(19) United States
(12) Patent Application Publication
(10) Pub. No.: US 2013/0029301 A1
(43) Pub. Date: Jan. 31, 2013

(54) Profiling Method

(71) Applicants: Andrew McLauchlan Lothian, Dundee (GB); Marcus Paul Wylie, Fife (GB); Inez Jane Brady, Dundee (GB); Alan William Maclachlan, Caledon (CA)

(72) Inventors: Andrew McLauchlan Lothian, Dundee (GB); Marcus Paul Wylie, Fife (GB); Inez Jane Brady, Dundee (GB); Alan William Maclachlan, Caledon (CA)

(73) Assignee: The Insights Group Limited, Dundee (GB)

(21) Appl. No.: 13/192,392

(22) Filed: Jul. 27, 2011

(51) Int. Cl. G09B 19/00

(52) U.S. Cl. 434/236

(57) ABSTRACT

A method, computer system and a computer program product for analyzing the personality of a user. The method comprises presenting a plurality of questions to the user and requesting the user to select one of multiple responses. Each question is associated with evaluation of one of N personality aspects and there are at least two questions associated with each said personality aspect. The method further comprises converting the selected response for each question to a score; summing the scores for the questions associated with each of said N personality aspects, to obtain an accumulated score for each of said N personality aspects; and selecting at least one of M psychological archetypes according to said accumulated scores. Each of said M psychological archetypes corresponds to a combination of at least two of said N personality aspects, and M is greater than N.

### BACKGROUND

The present invention relates to a computer implemented method for analyzing the personality of a human user. The invention also relates to a computer system on which the method is implemented, and a computer program product comprising a computer usable medium having control logic stored therein for causing a computer to implement the method.

Many psychometric tests for analyzing personality exist. Typically, such tests comprise a questionnaire which includes a plurality of questions designed to assess different aspects of personality. Once an individual's responses are obtained, these are processed to obtain results which characterize key elements of that individual's personality.

Analytical psychology originates with the work of the Swiss psychiatrist Carl Jung, who proposed a number of psychological types based on four basic functions thinking, sensing, feeling, and intuition. For each function, a differentiation between extraverted and introverted tendencies can be made. Thus, in combination, there is a total of 8 fundamental psychological types: extraverted thinking, extraverted sensing, extraverted feeling, extraverted intuition, introverted thinking, introverted sensing, introverted feeling, and introverted intuition. These 8 psychological types are referred to as “attitudinal functions”.

The availability of advanced computing facilities has enabled the development of various complex psychometric testing applications based on Jungian theories, with the ability to process large quantities of data and produce highly individualized personality profiles.

However, higher levels of differentiation between personality types typically require a greater number and/or more complex questions to be presented to the user. This places a limit on the level of differentiation that may be achieved, because it is not practical to present ever increasing numbers of questions, or ever more complicated questions to the user.

### SUMMARY

According to one aspect of the present invention there is provided a method to be implemented on a computer system for analyzing the personality of a user of the system, the method comprising:

presenting a plurality of questions to the user and requesting the user to select one of multiple responses in response to each question, wherein each question is associated with evaluation of one of N personality aspects and wherein there are at least two questions associated with each said personality aspects;

converting the selected response for each question to a score;

summing the scores for the questions associated with each of said N personality aspects, to obtain an accumulated score for each of said N personality aspect;

selecting at least one of M psychological archetypes according to said accumulated scores, wherein each of said M psychological archetypes corresponds to a combination of at least two of said N personality aspects, and wherein M is greater than N.

According to another aspect of the present invention there is provided a computing system for analyzing the personality of a user of the system, the system comprising:—

an evaluator module configured to generate a plurality of questions to be presented to a user of the system and to prompt the user to select one of multiple responses in response to each question, wherein each question is associated with evaluation of one of N personality aspects and wherein there are at least two questions associated with each said personality aspect;

a scoring module configured to:
receive the user's selected responses;
convert the selected response for each question into a score;
write said scores to a storage module;
sum the scores for the questions associated with each of said N personality aspects to obtain an accumulated score for each of said N personality aspects; and
write said accumulated scores to a storage module; and
an archetype determining module configured to determine at least one of M psychological archetypes according to said accumulated scores, wherein each of said M psychological archetypes corresponds to a combination of at least two of said N personality aspects, and wherein M is greater than N.

According to another aspect of the present invention there is provided a computer usable medium having control logic stored therein for causing a computer to analyze the personality of a user of the system, the control logic comprising:—

first computer readable program code means for causing the computer to present a plurality of questions to the user and to request the user to select one of multiple responses in response to each question, wherein each question is associated with evaluation of one of N personality aspects and wherein there are at least two questions associated with each said personality aspect;

second computer readable program code means for causing the computer to:—
receive the user's selected responses; convert the selected response for each question into a score;
write said scores to a storage module;

sum the scores for the questions associated with each of said N personality aspects to obtain an accumulated score for each of said N personality aspects; and

write said accumulated scores to a storage module; and

third computer readable program code means for causing the computer to selecting at least one of M psychological archetypes according to said accumulated scores, wherein each of said M psychological archetypes corresponds to a combination of at least two of said N personality aspects, and wherein M is greater than N.

With the present invention, the questions presented to the user are designed to evaluate N personality aspects, whereas the results are able to differentiate between M personality types, where M is greater than N.

For example, N may be 8 and M may be 72. In this case, the N personality aspects can be reliably evaluated with, for example, 10 questions relating to each aspect, making a total of 80 questions. Nevertheless, the end result allows for differentiation between 72 psychological archetypes. By comparison, if an attempt were made to evaluate the psychological archetypes directly, a much larger number of questions would be required to achieve accuracy.

The N personality aspects may be attitudinal functions. The personality aspects may be: extraverted thinking, extraverted sensing, extraverted feeling, extraverted intuition, introverted thinking, introverted sensing, introverted feeling, and introverted intuition.

### BRIEF DESCRIPTION OF THE DRAWINGS

The present invention will now be described with reference to the accompanying drawings in which:

FIG. 1 shows a schematic representation of apparatus suitable for implementing the present invention;

FIG. 2 illustrates questions 1-4 of an exemplary evaluator;

FIG. 3a is a flow chart which illustrates the process of scoring the user's responses;

FIG. 3b is a flow chart which illustrates the process of relating the accumulated attitudinal function scores to archetypes;

FIG. 4a shows part of a first look-up table stored on a profile statement database module of the apparatus shown in FIG. 1;

FIG. 4b shows part of a second look-up table stored on a profile statement database module of the apparatus shown in FIG. 1;

FIG. 5 is an extract from a personality profile, showing the 10 primary archetypes identified for an individual, listed in order of relevance; and

FIG. 6 is another extract from a personality profile, showing the 72 archetypes arranged on a circular diagram, with the locations of the 10 primary archetypes listed in FIG. 5 circled.

### DETAILED DESCRIPTION OF ILLUSTRATIVE EMBODIMENTS

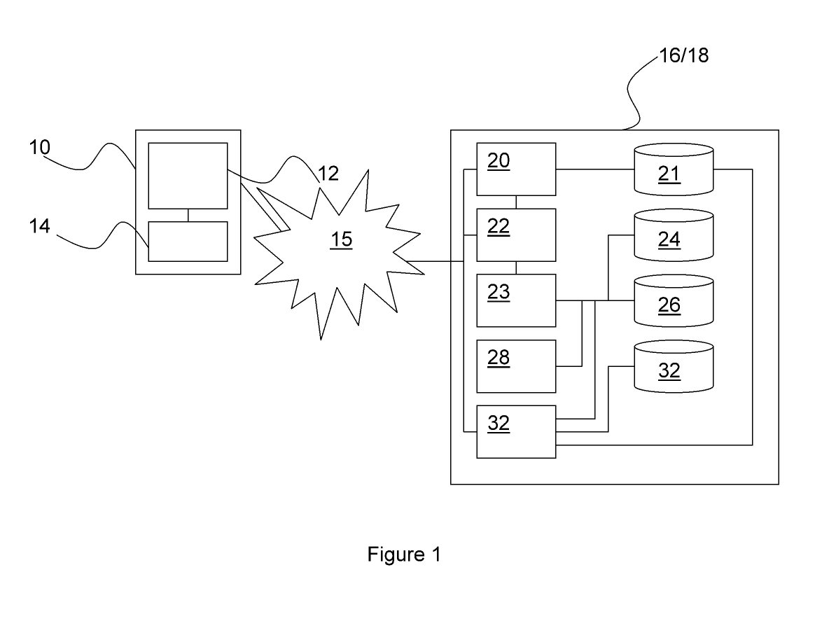

FIG. 1 shows a schematic representation of apparatus for implementing the present invention.

A computer terminal 10 has a display 12, input device(s) 14 such as a mouse, touchpad and/or keyboard, and a local processor device/microprocessor (not shown), capable of running web browser software (not shown).

The computer terminal 10 is connectable via a network 15 such as the internet to a server computer 16.

The server computer 16 comprises a central processing unit/microprocessor (CPU) 18, which in turn comprises a verification module 20, a user details database module 21, an evaluator module 22, a scoring module 23, a temporary storage module 24, a results database module 26, an archetype determining module 28, a profile statement database module 30, and a profile generating module 32. It will be appreciated that aspects of the server computer may be distributed over one or more separate computing devices, if required. Moreover, the present invention may utilize one or more remotely located computing resources such as provided by a cloud computing service.

As illustrated, computer terminal 10 is connected via a network such as the internet or an internal network to a server computer 16. However, it will be appreciated that the processing discussed below in relation to the server computer may be performed by the local processor device of computer terminal 10 if required, in which case there is no requirement for a remotely located server. In this case, the local processor device of computer terminal 10 may comprise verification module 20, user details database module 21, evaluator module 22, scoring module 23, temporary storage module 24, results database module 26, archetype determining module 28, profile statement database module 30, and profile generating module 32.

In use, a user of computer terminal 10 accesses the server computer via the network using a web browser, such that web pages generated by the server computer can be displayed on the screen 12 of the computer terminal and interacted with by means of input device(s) 14. Alternatively, in the case where the method is implemented directly on computer terminal 10, the user may simply launch the application on the terminal computer by selecting an icon associated with the application.

When the user initially accesses the server computer, or launches the application on their computer, the verification module 20 generates a log-in screen which prompts the user to enter a pre-allocated username and password. If the username and password entered by the system are both found to match details stored in the user details database module 21, the user is considered to be an authorized user, and the evaluator module 22 will then generate an introduction screen. If the user is not recognized as an authorized user, an error message is generated.

In an alternative embodiment, the verification process may be omitted, in which case the verification module 20 is not required. For example, the evaluator may be provided on a website which is open to all, such that it is not required to verify the identity of a user before they are allowed access to the evaluator. Alternatively, if the method is implemented on a standalone computer terminal, it may be assumed that any user of that computer is entitled to use the application. In either case, any necessary user details may be collected by the evaluator module and sent to the user database module during the survey process by the evaluator module.

The introduction screen generated by the evaluator module 22 welcomes the user to the test, and gives basic details of the test, such as how to answer the questions, how many questions to expect, and how long the test will take to complete. It may also contain information about privacy policies and/or other terms and conditions, and ask for confirmation that the user agrees to these terms and conditions and wishes to proceed with the test. The introduction screen, or a subsequent screen, may also ask for certain personal and/or demographic details, including the gender of the user. These details are stored in the user details database module 21.

Once the user has indicated that they wish to proceed with the test, the evaluator module 22 presents a series of 80 questions in the form of an “evaluator” to the user.

The 80 questions comprise 8 sets of 10 questions, the questions of each set being designed to measure or evaluate each of the eight attitudinal functions derived from Jungian theories. The 80 questions are ordered in such a way that the questions associated with each attitudinal function are randomly distributed throughout the series of questions, to ensure that the user is not aware of pattern. It will be appreciated that the evaluator may be adapted to present a different number of questions, without departing from the principles of the invention. It is desirable but not essential to have a number of questions which is a multiple of N, where N is the number of personality aspects or attitudinal functions being evaluated. This allows for equal numbers of questions to be directed to each of the personality aspects/attitudinal functions. In the case of 8 attitudinal functions, it is desirable for the number of questions to be a multiple of 8. In addition, further questions which are not used in the personality profile may be included as examples and/or for research purposes.

Each question can be answered on a 7 point Likert scale ranging from “Never” to “Always”.

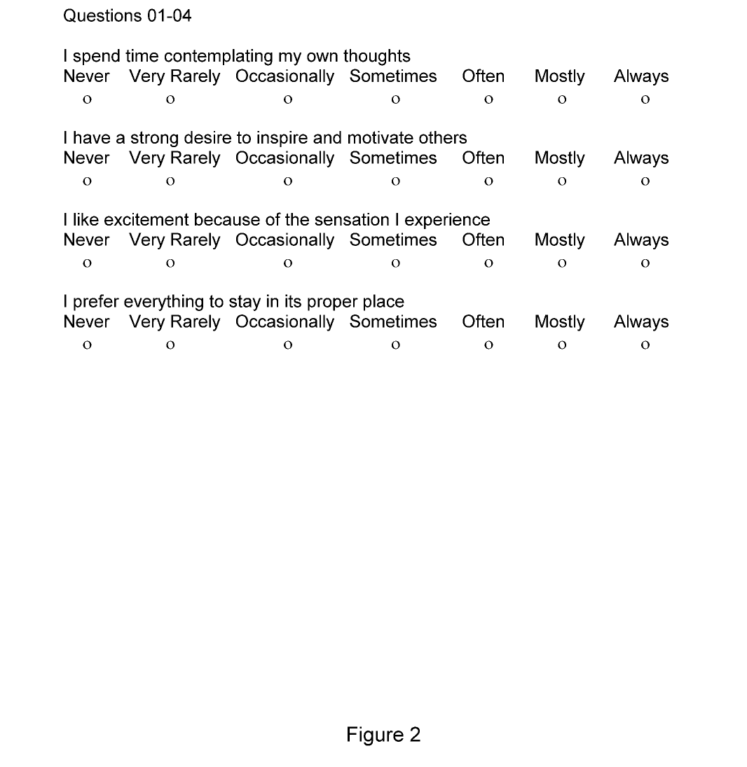

FIG. 2 illustrates questions 1-4 of an exemplary evaluator which are presented to a user in a single screen. Beneath each question are indicated the seven possible responses: “Never”, “Very Rarely”, “Occasionally”, “Sometimes”, “Often”, “Mostly”, and “Always”. It will be appreciated that the evaluator may be adapted to present a different number of options, without departing from the principles of the invention.

The evaluator module 22 prompts the user to select one response for each question by clicking on the circle below that response. If the user selects a second response, their selection is considered to have changed to that second response. It is not possible for the user to select more than one response for a single question.

Once the user has selected responses for all four questions, the evaluator module prompts them to confirm they are ready to proceed to the next questions. If any of the questions does not have a response, an error message is returned, indicating that the user should select a response before proceeding. Once responses to all four questions have been selected, and the user has confirmed they are ready to proceed, a screen with the next four questions is presented to the user. It will be appreciated that a different number of questions may be presented to the user on each screen, without departing from the principles of the invention. For example, a single question may be presented in each screen. Or, at the other end of the scale, all of the questions may be presented to the user in a single screen.

The process of presenting questions to the user continues until the user has provided answers to all 80 questions.

The scoring module 23 records each response in the form of a score, ranging from 0 for “Never” through 6 for “Always”. The scoring module then cycles through the 9 responses associated with each of the eight Attitudinal Functions, and calculates the total score, to give a score for each attitudinal function.

The possible score for each Attitudinal Function ranges from 0 (if all questions for that Function have been answered with “Never”) to 54 (if all questions for that Function have been answered with “Always”). In general, the higher the score, the greater the preference for that attitudinal function.

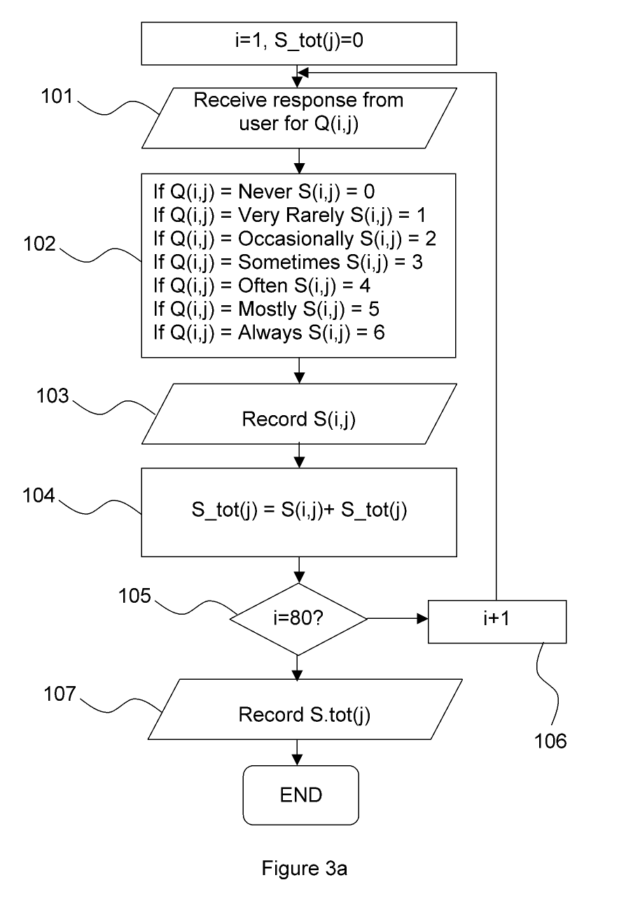

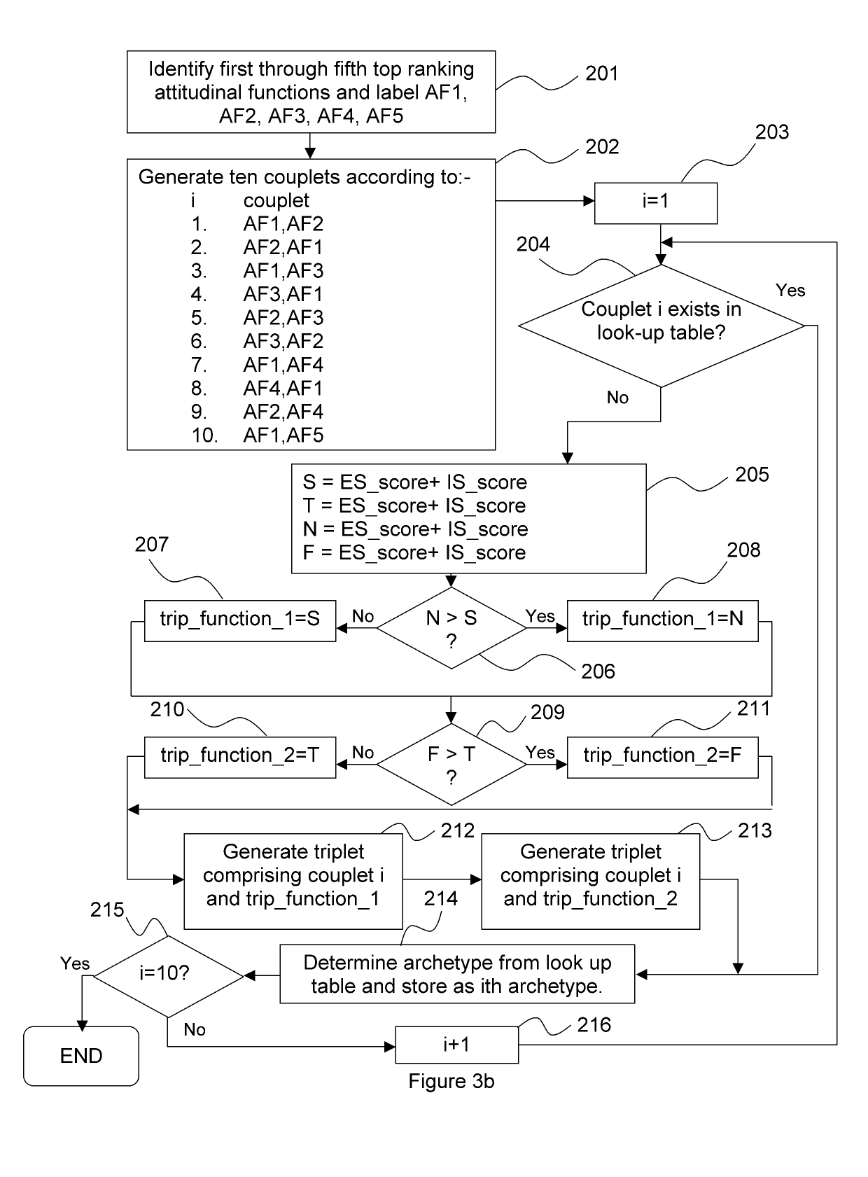

The scoring process is illustrated in more detail in the flowchart of FIG. 3a.

Each question Q has an associated variable i, which is a number from 1 to 80 representative of the order in which the questions are presented to the user. Each question Q also has an associated variable j which is a number from 1 to 8, and which represents the attitudinal function associated with that question. j may be related to the attitudinal functions as shown in Annex 1, although it will be appreciated that the assignment of the values of j to the attitudinal functions is arbitrary.

Initially, i=1, which represents question 1. The value of j depends on the attitudinal function which question 1 is intended to measure.

In the first iteration of step 101, the Evaluator module receives the user's response to question 1. At step 102, the Evaluator module converts the user's response to question 1 into a score S(1,j) from 0 to 6, and writes this score to results database module 26 at step 103. At step 104, the accumulated score S_tot(j) for the relevant attitudinal function is calculated and written to temporary storage module 24.

At step 105 it is determined whether i=80. In the first iteration, the answer is no. Thus, i is incremented by 1 at step 106, and the process returns to step 101, to repeat steps 101 to 105 for question 2. The process continues in this way until step 105 has been competed for question 80, at which point it is determined that i=80 at step 106, and the process proceeds to step 107. At step 107, the final eight values for S_tot(j) are written to results database 26, and the process ends.

Alternatively, the questions within the evaluator may be named a01, a02, etc, and the accumulated scores for the attitudinal functions may then be calculated according to a set of predetermined algorithms. In one example, the following set of algorithms are used:—

ES=k(+a03+a04+a09+a13+a31+a33+a52+a68+a76)

ET=k(+a11+a12+a21+a26+a55+a58+a64+a74+a77)

EN=k(+a08+a15+a25+a36+a42+a51+a62+a67+a71)

EF=k(+a02+a10+a22+a35+a41+a50+a69+a75+a78)

IN=k(+a01+a20+a24+a29+a30+a46+a48+a60+a79)

IF=k(+a05+a17+a18+a27+a39+a49+a63+a65+a73)

IS=k(+a06+a19+a28+a32+a45+a47+a56+a59+a80)

IT=k(+a07+a16+a34+a37+a38+a43+a44+a53+a57) (1)

where k is a scaling or normalising constant which may be set to 1.

In this example, only 72 of the 80 questions are used to calculate the total scores, whilst the remaining 8 questions are used for research purposes.

In the embodiment illustrated by FIG. 3a and the embodiment represented by set of algorithms (1), the accumulated score may simply be the sum of the scores for the individual questions. Alternatively, the accumulated score may be scaled, normalised or created with missing values.

In both embodiments, a score for each question, and the accumulated score for each attitudinal function is stored in the results database module.

This information enables the attitudinal functions to be ranked in order of “strength” based on the respondent's score for each function. The highest scoring attitudinal function is termed the “dominant function”. The dominant function defines, at a basic level, the personality type of the respondent.

Although useful, the differentiation between personality types given by ranking the 8 attitudinal functions is relatively crude. By identifying a dominant function, any individual is categorized as one of only eight personality types. Although further differentiation is given by the ranking of the other attitudinal functions, this differentiation is difficult for anyone other than a trained psychologist or typologist to interpret, and has previously been difficult to quantify in a way that is meaningful for a wider audience.

However, the present inventors have found a way to relate the eight attitudinal functions to a larger number of psychological archetypes, in order to allow greater differentiation between personality types, in a quantified and readily understood manner, and without the need to increase the number or complexity of the questions presented in the evaluator.

A psychological archetype epitomizes a particular personality trait, and is characterized by a term such as “Mother”, “Father” or “Entrepreneur” which evokes that personality trait. Whilst psychological archetypes have been employed by psychologists since the concept was originally advanced by Jung, there has previously been no attempt to categorize individuals into archetypes, based on their responses to questions intended to measure their preference for eight attitudinal functions.

The inventors have established that attitudinal functions can be related to archetypes, by looking at combinations of attitudinal functions. Based on eight attitudinal functions, and given that the ordering of the attitudinal functions is important (i.e., NT and TN, for example, count as two different pairs), the obvious total number of pairs or “couplets” is 8*7=56. However, the inventors have found that this is not sufficient to cover a full spectrum of personality types. Moreover, certain of the 56 available pairs have been found to relate to more than one archetype, such that further differentiation is required.

The inventors have found that these issues can be addressed by replacing those couplets with “triplets”, i.e., groups of three attitudinal functions.

In particular, the inventors have established a set of 72 archetypes, 40 of which relate to pairs of attitudinal functions, and 32 of which relate to triplets. More specifically, 16 of the available 56 pairs of attitudinal functions do not have associated archetypes. Each of these 16 couplets is combined with a first additional function to create a first triplet, and with a second additional function to create a second triplet, giving rise to 32 triplets in total Annex 2 lists the 72 archetypes alongside the couplet/triplet they relate to. It will be appreciated that the names of the archetype associated with a particular couplet or triplet may change.

The 16 couplets which do not have associated functions comprise 8 couplets associated with perception and 8 couplets associated with judgment. Each of the 8 “perception” couplets is combined with N to give a first triplet and with S to give a second triplet, giving rise to 16 triplets in total. Similarly, each of the 8 “judgment” couplets is combined with T to give a first triplet and with F to give a second triplets, giving rise to 16 triplets in total. The resulting 32 triplets each have an associated archetype, as listed in Annex 2.

The process of determining archetypes is explained with reference to the flowchart of FIG. 3b. Once the attitudinal functions are ranked in order of strength they may be labeled AF1, AF2 etc, where 1 represents the dominant function, 2 represents the first auxiliary function, and so on. At step 201, the archetype determining module 28 selects the 5 top ranking attitudinal functions AF1 through AF5. At step 202, these are combined to create 10 couplets according to the set of algorithms below:—

1. AF1,AF2

2. AF2,AF1

3. AF1,AF3

4. AF3,AF1

5. AF2,AF3

6. AF3,AF2

7. AF1,AF4

8. AF4,AF1

9. AF2,AF4

10. AF1,AF5 (2)

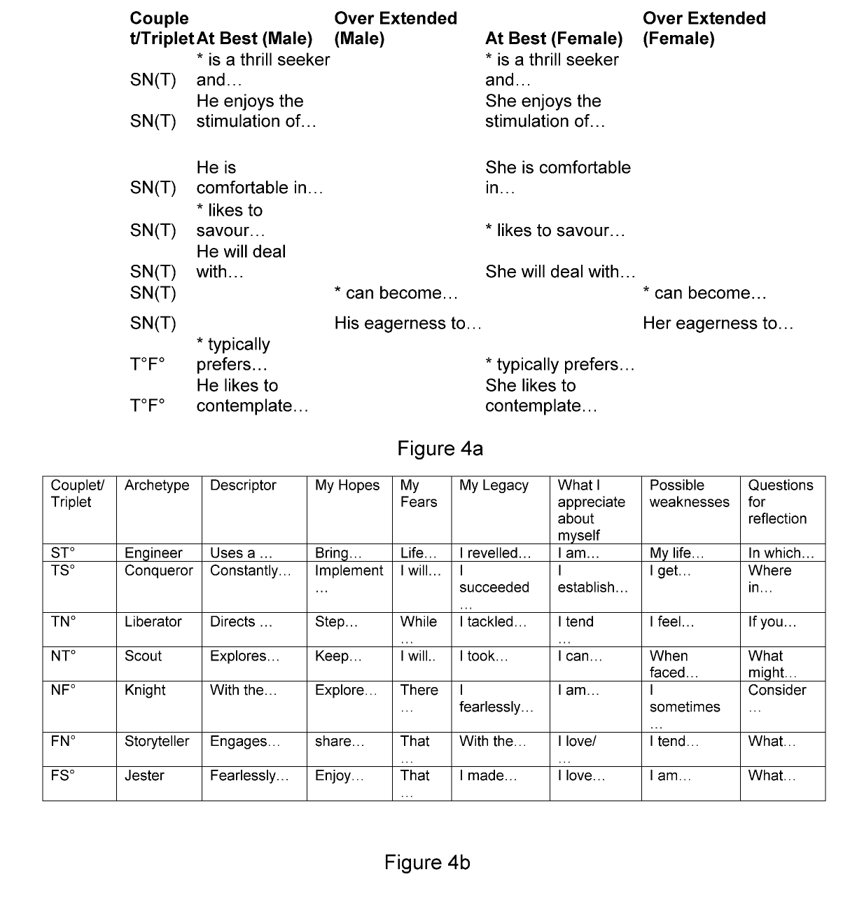

At step 203, I is set to 1, and the flow proceeds to step 204 where the archetype determining module determines whether the first couplet exists in a look-up table such as that illustrated in FIG. 4a, or based on Annex 2. As discussed above, there are 56 possible combinations of attitudinal functions, of which only 40 relate to archetypes. If the first couplet is one of the 40 with an associated archetype, the answer at step 204 is Yes, and the flow proceeds directly to step 214 where archetype determining module determines the name of the archetype and records this for the first archetype. At step 215, the archetype determining module determines whether i=10. For the first archetype the answer is clearly no. Accordingly, i is incremented by 1 at step 216 and the flow reverts to step 204.

On the other hand, if the first couplet is one of the 16 which do not have an associated archetype, the answer at step 204 is no, and the flow proceeds to step 205 where the archetype determining module sums the scores obtained for the following pairs of attitudinal functions:—

introverted and extraverted sensing;

introverted and extraverted thinking;

introverted and extraverted intuition; and introverted and extraverted feeling.

This gives four separate scores for sensing, thinking, intuition and feeling respectively. That is to say:—

S=ES_score+IS_score

T=ET_score+IT_score

N=EN_score+IN_score

F=EF_score+IF_score (3)

Then, the flow proceeds to steps 206 through 208, where the archetype determining module then determines a “perceiving” function for the user (trip_function_{—}1), which is either Intuitive, N, if N>S or Sensing, S if S>N.

Then, the flow proceeds to steps 209 through 210, where the archetype determining module then determines a “judging” function for the user (trip_function_{—}2), which is either Thinking, T if T>F or Feeling, F if F>T.

At steps 212 and 213, the archetype determining module generates two alternative triplets by respectively adding trip_function_{—}1 and trip_function_{—}2 to the first couplet.

The flow then proceeds to step 214 where these triplets are looked up in the look-up table. Due to the way in which archetypes are assigned, only one of the two triplets will have an associated archetype. The archetype determining module stores this archetype as the first archetype for the user. i is then incremented by 1 at step 216 and the flow reverts to step 204.

The process is then repeated for the second through tenth couplets to identify the user's ten primary archetypes.

These results are written to the results database module 26.

It will be appreciated that the selection of 10 primary archetypes is merely an example, and a different number of primary archetypes may be selected.

To illustrate the archetype determining process in more detail, an example for a particular user A is given.

The accumulated and scaled scores for the 8 attitudinal functions calculated from user A's responses to the evaluator questions are as follows:

ES=57

ET=76

EN=82

EF=81

IN=87

IF=93

IS=77

IT=63

These are first ranked as follows:

IF=93

IN=87

EI=82

EF=81

IS=77

ET=76

IT=63

ES=57

These are converted into couplets using the set of algorithms (2), as follows:

1. IFIN

2. INIF

3. IFEN

4. ENIF

5. INEN

6. ENIN

7. IFEF

8. EFIF

9. INEF

10. IFIS

These couplets are converted into archetypes. If an associated archetype does not exist, the result n/a is returned.

1. Lover

2. Healer

3. Philanthropist

4. Knight

5. n/a

6. n/a

7. n/a

8. n/a

9. Consoler

10. Companion

As couplets 5 through 8 do not have associated archetypes, the perceiving and judging functions for the user are calculated for the user, using the set of algorithms (3).

S=57+77=134

T=76+63=139

N=87+82=169

F=93+81=174

As N>S, the user's perceiving function is Intuition, N, and as F>T, the user's judging function is Feeling, F.

These functions are used to generate two alternative triplets for each of couplets 5. through 8.

5. INEN=INEN(N) or INEN(F)

6. ENIN=ENIN(N) or ENIN(F)

7. IFEF=IFEF(N) or IFEF(F)

8. EFIF=EFIF(N) or EFIF(F)

These triplets are then converted into archetypes as follows: —

5. INEN(F)=Prophet

6. ENIN(F)=Wanderer

7. IFEF(N)=Angel

8. EFIF(N)=Rescuer

Once the primary archetypes have been determined by the archetype determining module 28 and written to the results database module 26, the profile generating module 32 generates a personality profile for the user.

The profile may comprise a verbal description of the user's personality. To this end, the profile generating module 32 obtains the dominant attitudinal function (ie the highest scoring attitudinal function) and the 10 primary archetypes for an individual from the results database module 26. These results are used to select suitable statements from a profile database 30.

FIGS. 4a and 4b illustrate extracts from two look-up tables which may be stored in profile database 30.

FIG. 4a is used to derive a “Personal Overview” section for the user. The 72 archetypes are listed in the first column in terms of the related couplet/triplet. The following four columns are titled “At best (Male)”, “Over Extended (Male)”, “At best (Female)”, and “Over Extended (Female)”. Each couplet or triplet has a number of associated statements. More positive comments are categorized as “at best”, whilst more negative comments are categorized as “over extended”, and placed in the appropriate columns. The columns for male and female contain the same statements for the same couplet/triplet, except that gender specific terms such are adjusted. Some of the statements have an asterisk which will automatically be replaced by the user's name.

To produce the Personal Overview section of the personality profile, the profile generating module obtains the name and gender of the user from the user details database, and randomly selects four statements from the gender appropriate “at best” column, and two statements from the gender appropriate “over extended” column, based on the user's primary archetypes. Any asterisks in the selected statements are then replaced by the user's first name, and the completed statements are written into a profile template under the heading “personal profile” to complete that section of the profile.

The Personal Overview section may have the following structure:

Paragraph 1=First archetype statements+second archetype statements

Paragraph 2=Third archetype statements+fourth archetype statements

Paragraph 3=Fifth archetype statements+sixth archetype statements

Paragraph 4=Seventh archetype statements+eighths archetype statement

Paragraph 5=Ninth archetype statements

Paragraph 6=Tenth archetype statements (4)

FIG. 4b is used to derive subsequent sections of the personality profile. The 72 archetypes are listed in column 1, in terms of the related couplet/triplet. The associated archetype is listed in column 2, followed by a descriptor of that archetype in column 3. Columns 4 through 9 give archetype specific statements for each of 5 categories titled “My Hopes”, “My Fears”, “My Legacy”, “What I Appreciate About Myself”, “Possible Weaknesses”, and “Questions for Reflection”. Each of these categories relates to a separate section of the personality profile. In FIG. 4b there is only one statement per category associated with each archetype. However, there is preferably more than one statement associated with each archetype.

To produce these sections of the personality profile, the profile generating module randomly selects a plurality of statements for each section, based on the user's primary archetypes. The selected statements are then written into the profile template, under appropriate headings to complete these sections of the profile.

The profile statements database module 30 is configured to include a large number of statements, such that there are typically many more statements for each category, attitudinal function and archetype that would be required in a typical profile. This allows statements to be randomly selected from a plurality of suitable statements. This enhances the individuality of the personal profile, whilst ensuring that the profile accurately reflects the individual's personality.

The profile generating module 32 also writes to the profile template a list of the primary archetypes in order of rank, and together with a brief description of the archetype and the couplet or triplet of attitudinal functions which relates to that archetype.

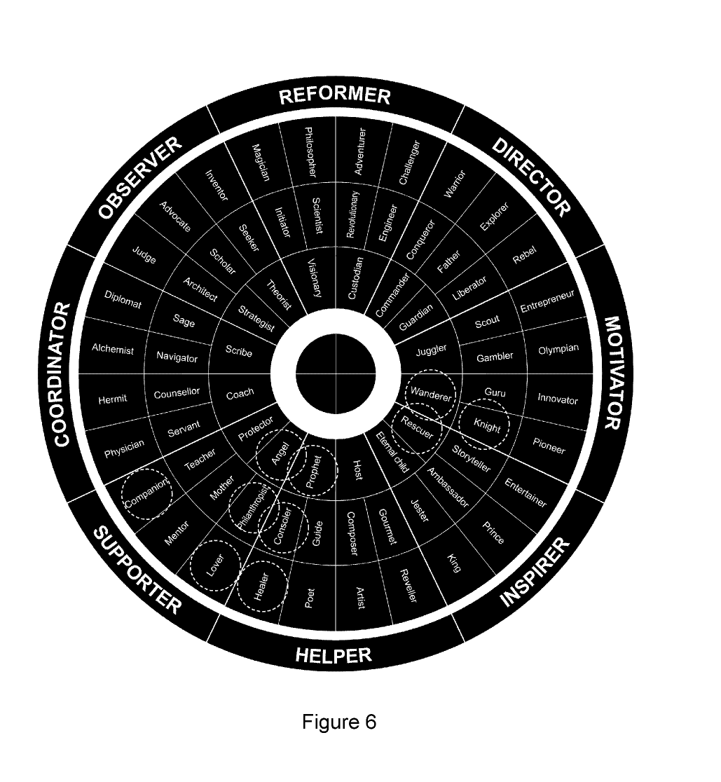

The location of these archetypes on a circular model or “Wheel”, such as that illustrated in FIG. 6, which sets out the 72 available archetypes is also presented to the user. The couplet or triplet of attitudinal functions relating to each of the archetype can be found in Annex 2.

By relating Annex 2 to FIG. 6, the following structural aspects of the wheel may be appreciated.

Introversion is represented on the left of the wheel, and extroversion is represented on the right.

The outer layer of the wheel represents Jungian types where the attitude (introversion or extroversion) of the dominant and auxiliary functions in the pair is the same. For example, INIT, ENET etc.

The middle layer represents an extension to the Myers-Briggs Type Indicator from 16 to 28 attitude functions where the attitude of the dominant function of the pair is opposite to that of the auxiliary function. For example, INET, ENIT, etc.

The inner layer represents pairs of the same function but with opposite attitudes. For example, INEN, etc.

The wheel has 8 sections named Reformer, Director, Motivator, Inspirer, Helper, Supporter, Coordinator, and Observer. All of the pairs of attitudinal functions in the Director section have ET as the dominant function. Likewise, all of the pairs in the Motivator section have EN as the dominant function.

The only sections in which all of the pairs do not begin with the same dominant function are the Helper and Reformer sections, in which either IN or ES is the dominant function. In the Helper section, this is done with a Feeling preference and in the Reformer section, this is done with a Thinking preference.

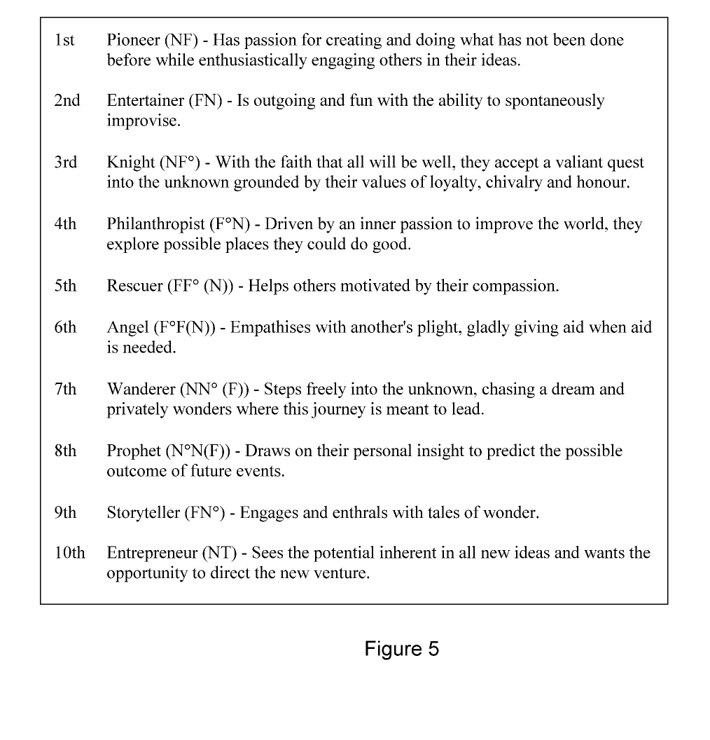

FIG. 5 lists the 10 primary archetypes selected for one individual. The position of these archetypes on the wheel model are identified by circles in FIG. 6.

In a preferred embodiment, a set of archetype cards may be provided. The set comprises one card for each archetype, and shows a graphic specific to that archetype on one side, and the name of the archetype together with a brief description on the other side. The card also indicates the couplet or triplet of attitudinal functions which relates to that archetype. Accordingly, each card has a corresponding position on the wheel described above.

In the description above, it is assumed that the system will identify 10 primary archetypes for the user. However, it will be appreciated that any number of primary archetypes may be selected. For example, in one alternative embodiment, 6 primary archetypes are identified.

The profile generating module 32 may also generate a bar graph or other graphical presentation which indicates the extent of an individual's preferences for each of the eight attitudinal functions. This is written to the profile template.

The profile generating module 32 may also generate a graph which indicates the spread of responses to the questions in the evaluator (between “Never” and “Always”), broken down by attitudinal function. This is written to the profile template.

Once the profile template is completed, the profile generating module 32 publishes the document as, for example, a pdf document, which is sent to the user over the network.

Embodiments of the invention are described above. It will be appreciated that various modifications and variations of the described embodiment may be made, without departing from the spirit and scope of the invention.

The method of the invention may be implemented using one or more third party applications either alone or in combination. For example, the evaluator may be implemented using online survey software Globalpark®, whilst the scoring a profile generation may be implemented using a spreadsheet program such as Microsoft Excel O. Alternatively, the method may be implemented by a single bespoke software application.

In the specification, the term “questions” may refer to any statement where a response to that statement is understood to be required. Thus, for example, the statement “I spend time contemplating my own thoughts” constitutes a question if the user is required to select a response which represents the extent to which this statement applies to them.

Annex 1

| j | AF | Symbol | Shorthand |
|---|---|---|---|
| 1 | Extraverted Thinking | T | ET |
| 2 | Extraverted Sensing | S | ES |
| 3 | Extraverted Feeling | F | EF |
| 4 | Extraverted Intuition | N | EN |
| 5 | Introverted Thinking | T° | IT |
| 6 | Introverted Sensing | S° | IS |
| 7 | Introverted Feeling | F° | IF |
| 8 | Introverted Intuition | N° | IN |

Annex 2

| Couplet or Triplet | | Archetype |
|---|---|---|
| ESIT | ST° | Engineer |
| ETIS | TS° | Conqueror |
| ETIN | TN° | Liberator |
| ENIT | NT° | Scout |
| ENIF | NF° | Knight |
| EFIN | FN° | Storyteller |
| EFIS | FS° | Jester |
| ESIF | SF° | Gourmet |
| INEF | N°F | Consoler |
| IFEN | F°N | Philanthropist |
| IFES | F°S | Teacher |
| ISEF | S°F | Servant |
| ISET | S°T | Sage |
| ITES | T°S | Architect |
| ITEN | T°N | Seeker |
| INET | N°T | Initiator |
| ESET | ST | Challenger |
| ETES | TS | Warrior |
| ETEN | TN | Rebel |
| ENET | NT | Entrepreneur |
| ENEF | NF | Pioneer |
| EFEN | FN | Entertainer |
| EFES | FS | King |
| ESEF | SF | Reveller |
| INIF | N°F° | Healer |
| IFIN | F°N° | Lover |
| IFIS | F°S° | Companion |
| ISIF | S°F° | Physician |
| ISIT | S°T° | Diplomat |
| ITIS | T°S° | Judge |
| ITIN | T°N° | Inventor |
| INIT | N°T° | Magician |
| INIS(T) | N°S°(T) | Philosopher |
| ISIN(F) | S°N°(F) | Hermit |
| ISIN(T) | S°N°(T) | Alchemist |
| ESEN(F) | SN(F) | Artist |
| INIS(F) | N°S°(F) | Poet |
| ENES(T) | NS(T) | Olympian |
| ENES(F) | NS(F) | Innovator |
| ESEN(T) | SN(T) | Adventurer |
| ETEF | TF | Explorer |
| EFET | FT | Prince |
| ITIF | T°F° | Advocate |
| IFIT | F°T° | Mentor |
| ESIN(F) | SN°(F) | Composer |
| INES(F) | N°S(F) | Guide |
| ISEN(F) | S°N(F) | Counsellor |
| ISEN(T) | S°N(T) | Navigator |
| ENIS(T) | NS°(T) | Gambler |
| ENIS(F) | NS°(F) | Guru |
| ESIN(T) | SN°(T) | Revolutionary |
| INES(T) | N°S(T) | Scientist |
| ETIF | TF° | Father |
| ITEF | T°F | Scholar |
| EFIT | FT° | Ambassador |
| IFET | F°T | Mother |
| ESIS(T) | SS°(T) | Custodian |
| ETIT(S) | TT°(S) | Commander |
| ETIT(N) | TT°(N) | Guardian |
| ENIN(T) | NN°(T) | Juggler |
| ENIN(F) | NN°(F) | Wanderer |
| EFIF(N) | FF°(N) | Rescuer |
| EFIF(S) | FF°(S) | Eternal Child |
| ESIS(F) | SS°(F) | Host |
| INEN(F) | N°N(F) | Prophet |
| IFEF(N) | F°F(N) | Angel |
| IFEF(S) | F°F(S) | Protector |
| ISES(F) | S°S(F) | Coach |
| ISES(T) | S°S(T) | Scribe |
| ITET(N) | T°T(N) | Theorist |
| ITET(S) | T°T(S) | Strategist |
| INEN(T) | N°N(T) | Visionary |

What is claimed:

1. A method to be implemented on a computer system for analyzing the personality of a user of the system, the method comprising:
presenting a plurality of questions to the user and requesting the user to select one of multiple responses in response to each question, wherein each question is associated with evaluation of one of N personality aspects and wherein there are at least two questions associated with each said personality aspects;
converting the selected response for each question to a score;
summing the scores for the questions associated with each of said N personality aspects, to obtain an accumulated score for each of said N personality aspect;
selecting at least one of M psychological archetypes according to said accumulated scores, wherein each of said M psychological archetypes corresponds to a combination of at least two of said N personality aspects, and wherein M is greater than N.

2. The method of claim 1 further comprising:
identifying P different combinations of 2 personality aspects based on the accumulated score obtained for each said personality aspect, where P is greater than or equal to 1.

3. The method of claim 2 wherein said P different combinations of 2 personality aspects are formed from the personality aspects which higher accumulated scores.

4. The method of claim 2 further comprising:
looking up each of said one or more P different combinations in a database which relates combinations of personality aspects to personality archetypes, in order to determine a personality archetype which corresponds to the respective combination of personality aspects, wherein the database is stored in a storage module.

5. The method of claim 4 further comprising:
determining whether a personality archetype corresponding to one or more of said P combinations exists in the database, and, in the event that a personality archetype corresponding to one or more of said P combinations is not found in the database:—
determining a third personality aspect for the user;
adding said third personality aspect to the respective combination of two personality aspects to make a combination of 3 personality aspects; and
looking up each of said combinations of 3 personality aspects in said database, in order to determine a personality archetype which corresponds to the respective combination of personality aspects.

6. The method of claim 1 wherein at least some of said M psychological archetypes corresponds to a combination of 2 of said N personality aspects.

7. The method of claim 6 wherein 40 of said M psychological archetypes correspond to a combination of 2 of said N personality aspects.

8. The method of claim 1 wherein at least some of said M psychological archetypes corresponds to a combination of 3 of said N personality aspects.

9. The method of claim 8 wherein 32 of said M psychological archetypes correspond to a combination of 3 of said N personality aspects.

10. The method of claim 1 wherein the number M of said psychological archetypes is 72.

11. The method of claim 1 wherein the N personality aspects are attitudinal functions.

12. A computing system for analyzing the personality of a user of the system, the system comprising:
an evaluator module configured to generate a plurality of questions to be presented to a user of the system and to prompt the user to select one of multiple responses in response to each question, wherein each question is associated with evaluation of one of N personality aspects and wherein there are at least two questions associated with each said personality aspect;
a scoring module configured to:
receive the user's selected responses;
convert the selected response for each question into a score;
write said scores to a storage module;
sum the scores for the questions associated with each of said N personality aspects to obtain an accumulated score for each of said N personality aspects; and
write said accumulated scores to a storage module; and
an archetype determining module configured to determine at least one of M psychological archetypes according to said accumulated scores, wherein each of said M psychological archetypes corresponds to a combination of at least two of said N personality aspects, and wherein M is greater than N.

13. The computing system of claim 12 wherein the archetype determining module is further configured to:
identify P different combinations of 2 personality aspects based on the accumulated score obtained for each said personality aspect, where P is greater than or equal to 1.

14. The computing system of claim 13 wherein the archetype determining module is further configured to:
look up each of said one or more P different combinations in a database which relates combinations of personality aspects to personality archetypes, in order to determine a personality archetype which corresponds to the respective combination of personality aspects, wherein the database is stored in a storage module.

15. The computing system of claim 14 wherein the archetype determining module is further configured to:
determine whether a personality archetype corresponding to one or more of said P combinations exists in the database, and, in the event that a personality archetype corresponding to one or more of said P combinations is not found in the database:—
determine a third personality aspect for the user;
add said third personality aspect to the respective combination of two personality aspects to make a combination of 3 personality aspects; and
look up each of said combinations of 3 personality aspects in said database, in order to determine a personality archetype which corresponds to the respective combination of personality aspects.

16. The computing system of claim 12 wherein at least some of said M psychological archetypes corresponds to a combination of 2 of said N personality aspects.

17. The computing system of claim 12 wherein at least some of said M psychological archetypes corresponds to a combination of 3 of said N personality aspects.

18. The computing system of claim 12 wherein the number M of said psychological archetypes is 72.

19. A computer usable medium having control logic stored therein for causing a computer to analyze the personality of a user of the system, the control logic comprising:
first computer readable program code means for causing the computer to present a plurality of questions to the user and to request the user to select one of multiple responses in response to each question, wherein each question is associated with evaluation of one of N personality aspects and wherein there are at least two questions associated with each said personality aspect;
second computer readable program code means for causing the computer to:
receive the user's selected responses;
convert the selected response for each question into a score;
write said scores to a storage module;
sum the scores for the questions associated with each of said N personality aspects to obtain an accumulated score for each of said N personality aspects; and
write said accumulated scores to a storage module; and
third computer readable program code means for causing the computer to select at least one of M psychological archetypes according to said accumulated scores, wherein each of said M psychological archetypes corresponds to a combination of at least two of said N personality aspects, and wherein M is greater than N.

20. The computer usable medium of claim 19 wherein the archetype determining module is further configured to:
identify P different combinations of 2 personality aspects based on the accumulated score obtained for each said personality aspect, where P is greater than or equal to 1.

21. The computer usable medium of claim 20 further comprising computer readable program code means for causing the computer to:
look up each of said one or more P different combinations in a database which relates combinations of personality aspects to personality archetypes, in order to determine a personality archetype which corresponds to the respective combination of personality aspects, wherein the database is stored in a storage module.

22. The computer usable medium of claim 21 further comprising computer readable program code means for causing the computer to:
determine whether a personality archetype corresponding to one or more of said P combinations exists in the database, and, in the event that a personality archetype corresponding to one or more of said P combinations is not found in the database:—
determine a third personality aspect for the user;
add said third personality aspect to the respective combination of two personality aspects to make a combination of 3 personality aspects; and look up each of said combinations of 3 personality aspects in said database, in order to determine a personality archetype which corresponds to the respective combination of personality aspects.

23. The computer usable medium of claim 19 wherein at least some of said M psychological archetypes corresponds to a combination of 2 of said N personality aspects.

24. The computer usable medium of claim 19 wherein at least some of said M psychological archetypes corresponds to a combination of 3 of said N personality aspects.

25. The computer usable medium of claim 19 wherein the number M of said psychological archetypes is 72.
